(19) United States
(12) Patent Application Publication
(10) Pub. No.: US 2011/0045842 A1
(43) Pub. Date: Feb. 24, 2011

(54) Method and System For Updating A Social Networking System Based On Vehicle Events

(75) Inventors: Joseph Paul Rork, Canton, MI (US); Matthew Atwood Whitaker, Midland, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/544,621

(22) Filed: Aug. 20, 2009

(51) Int. Cl. G08G 1/123; H04W 4/00; H04W 24/00

(52) U.S. Cl. 455/456.1; 340/988; 455/466

(57) ABSTRACT

A computer-implemented method for automatically updating a social networking system based on vehicle events may include receiving login information at a nomadic device to permit network access to a social networking system. The method may also include wirelessly determining a vehicle operational status. Geographic location information indicating an approximate location of the vehicle may also be received. Based on the vehicle operational status and the location information, one or more messages may be generated. Network access to the social networking system using the login information may be obtained and the one or more messages to the social networking system may be transmitted over the network for updating information on the social networking system.

### BACKGROUND

1. Technical Field

One or more embodiments include a method and system for updating a social networking system based on vehicle events.

2. Background Art

FACEBOOK and TWITTER are online social networking tools. FACEBOOK offers a service in which users can communicate with friends and family, make new friends, upload pictures and videos, and share links, among other things. TWITTER is a micro-blogging website in which users can send short messages to other connected users in order to communicate with friends and family.

U.S. Pat. No. 7,174,243 issued to Lightner, et al provides a wireless, internet-based system for monitoring and analyzing both GPS and diagnostic data collected from a vehicle. Specifically, the Lightner implementation includes a system for collecting GPS and diagnostic data and analyzing them to provide improved determination and mapping of the vehicle's location.

U.S. Pat. No. 7,228,211 issued to Lowrey, et al. includes an in-vehicle telematics system featuring: 1) a controller; 2) a diagnostics system configured to receive diagnostic information from a host vehicle; 3) a position-locating system configured to determine the host vehicle's location information; 4) a communication interface configured to send additional information to a peripheral system other than the diagnostic position-locating systems; and, 5) a wireless transmitter configured to transmit information through a wireless network to an Internet-accessible website.

### SUMMARY

One aspect includes a computer-implemented method for automatically updating a social networking system based on vehicle events. The method may include receiving login information at a nomadic device (ND) permitting network access to a social networking system. In one embodiment, the social networking system may be a web-based entity. In this non-limiting embodiment, the method may further include transmitting the one or more messages and the vehicle location to the web-based entity.

The ND may a cellphone and the method may be implemented in computer software executing on the cellphone.

The method may further include wirelessly determining a vehicle operational status at the ND. The vehicle may located in proximity of the ND. In one embodiment, the vehicle operational status may be determined according to a pairing status between the NWCD and a vehicle computing system. Alternatively or additionally, the vehicle operational status may be based on a vehicle's ignition status.

The method may further include receiving geographic location information indicating an approximate location of the vehicle. The geographic location information may one or more user-defined locations.

The method may further include generating one or more messages based on the vehicle operational status and the location information. The one or more messages may identify a social networking system user arriving at a location, departing from a location, or both.

The method may further include obtaining network access to the social networking system using the login information. Additionally, the method may include transmitting the one or more messages to the social networking system over the network for updating information on the social networking system. The one or more messages and the vehicle location may be displayed at the social networking system.

The method may further include receiving vehicle ownership information. In this non-limiting embodiment, transmitting the one or more messages may further include transmitting the vehicle ownership information.

The method may further include receiving vehicle branding information. In this non-limiting embodiment, transmitting the one or more messages may further include transmitting the vehicle branding information.

Another aspect may include a computer-program product embodied in a computer-readable medium programmed for automatically updating a social networking system based on vehicle events. The computer-program product may include instructions for receiving login information permitting network access to a social networking system. The social networking system may be, in one embodiment, a short messaging service (SMS) program. Accordingly, the computer program product further includes instructions for transmitting the one or more messages and the vehicle location to the SMS program.

The computer-program product may further include instructions for wirelessly determining an operational status of a vehicle located in proximity to the ND. In one embodiment, the operational status of the vehicle may be based on a transmission position of the vehicle. Additionally or alternatively, the vehicle operational status may be determined based on a pairing status between the ND and a vehicle computing system and a transmission position of the vehicle.

The computer program product may further include instructions for receiving geographic location information indicating an approximate location of the vehicle. In one embodiment, the location information may include a name of a location. The location name may be user-defined.

The computer program product may further include instructions for generating one or more messages based on the vehicle operational status and the location information. The one or more messages may identify a social networking system user arriving at a location, departing from a location, or both.

Using the ND, the computer program product may include further instructions for obtaining network access to the social networking system using the login information. Using the ND, the computer program product may further include instructions for transmitting the one or more messages to the social networking system over the network for updating information on the social networking system.

The computer program product may further include instructions for receiving personal information identifying a social networking system user. The computer program product may further include instructions for transmitting the identifying personal information with the one or more messages.

Another aspect may include a computer-implemented system for automatically updating a social networking system based on vehicle events. The system may include at least one computer configured to pair the ND with a vehicle computing system. The at least one computer may be further configured to receive login information permitting network access to a social networking system.

The at least one computer may be further configured to determine an operational status of a vehicle located in proximity of the ND. The operational status of the vehicle may be determined based on a pairing status between the NWCD and the vehicle computing system.

The at least one computer may be further configured to receive geographic location information indicating an approximate location of the vehicle.

The at least one computer may be further configured to generate one or more messages based on the vehicle operational status and the location information.

The at least one computer may be further configured to obtain network access to the social networking system using the login information.

Additionally, the at least one computer may be further configured to transmit the one or more messages to the social networking system over the network for updating information on the social networking system.

### BRIEF DESCRIPTION OF THE DRAWINGS

The figures identified below are illustrative of some embodiments of the present invention. The figures are not intended to be limiting of the invention recited in the appended claims. Embodiments of the present invention, both as to their organization and manner of operation, together with further object and advantages thereof, may best be understood with reference to the following description, taken in connection with the accompanying drawings, in which:

FIG. 1 illustrates a vehicle computing system according to one of the various embodiments;

FIG. 2 illustrates a social networking system according to one of the various embodiments;

FIG. 3 illustrates an operation of the social networking system according to one of the various embodiments;

FIG. 4 illustrates an operation of the social networking system according to another one of the various embodiments;

FIG. 5 illustrates an operation of the social networking system according to yet another one of the various embodiments;

FIG. 6 shows a display viewed by a recipient of a social networking message according to one of the various embodiments.

### DETAILED DESCRIPTION

Detailed embodiments of the present invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

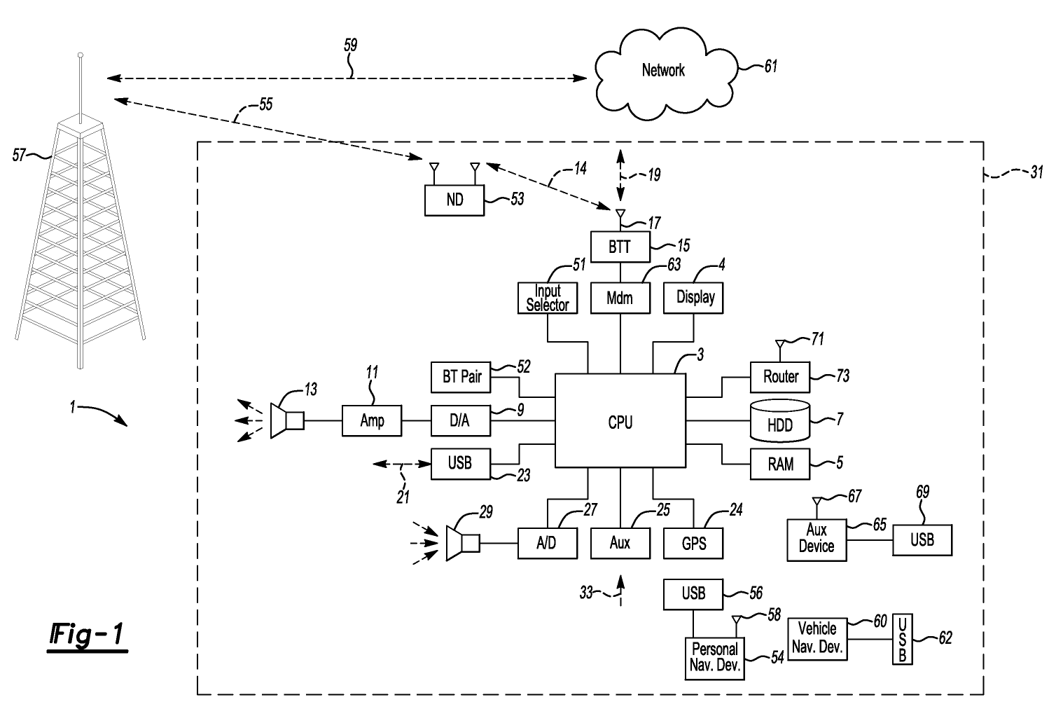

FIG. 1 illustrates an example block topology for a vehicle based computing system 1 for a vehicle 31. A vehicle enabled with a vehicle-based computing system may contain a visual front end interface 4 located in the vehicle. The user may also be able to interact with the interface if it is provided, for example, with a touch sensitive screen. In another illustrative “hands free” embodiment, the interaction occurs through audible speech and speech synthesis.

In the illustrative embodiment 1 shown in FIG. 1, a processor 3 controls at least some portion of the operation of the vehicle-based computing system. Provided within the vehicle, the processor executes software and allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor 3 is also provided with a number of different inputs allowing the user to interface with the processor 3. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor.

Outputs of the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 14 with a user's nomadic device 53 (e.g., cell phone, smart phone, PDA, etc.) (hereinafter referred to as “ND”). The ND 53 can then be used to communicate 59 with a network 61 outside the vehicle 31 through, for example, communication 55 with a cellular tower 57.

Exemplary communication between the nomadic device and the BLUETOOTH Transceiver is represented by signal 14.

Pairing a ND 53 and the BLUETOOTH transceiver 15 can be instructed through a button 52 or similar input, telling the CPU that the onboard BLUETOOTH transceiver will be paired with a BLUETOOTH transceiver in a ND 53.

Data may be communicated between CPU 3 and network 61 utilizing, for example, a data-plan, data over voice, or DTMF tones associated with ND 53. Alternatively, it may be desirable to utilize a modem 63 in order to transfer data between CPU 3 and network 61 over the voice band or other frequency range. In one illustrative embodiment, the processor 3 is provided with an operating system including an API to communicate with modem application software. The modem application software may access an embedded module or firmware on the BLUETOOTH transceiver to complete wireless communication with a remote BLUETOOTH transceiver (such as that found in a nomadic device).

In another embodiment, ND 53 includes a modem for voice band or broadband data communication. In the data-over-voice embodiment, a technique known as frequency division multiplexing may be implemented when the owner of the ND 53 can talk over the device while data is being transferred. At other times, when the owner is not using the device, the data transfer can use the whole bandwidth (300 Hz to 3.4 kHz in one example). Other modem and multiplexing techniques known in the art may be used.

If the user has a data-plan associated with the ND 53, it is possible that the data-plan allows for broad-band transmission and the system could use a much wider bandwidth (speeding up data transfer). In still another embodiment, ND 53 is replaced with a cellular communication device (not shown) that is affixed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data from network 61 can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54 having, for example, a USB connection 56 and/or an antenna 58, a vehicle navigation device 60 having a USB 62 or other connection, an onboard GPS device 24, or remote navigation system (not shown) having connectivity to network 61.

Further, the CPU 3 could be in communication with a variety of other auxiliary devices 65. These devices can be connected through a wireless 67 or wired 69 connection. Also, or alternatively, the CPU 3 could be connected to a vehicle based wireless router 73, using for example a WiFi 71 transceiver. This could allow the CPU to connect to remote networks in range of the local router 73.

Processor 3 may also be in communication with a vehicle data communications bus (not shown) for sending and/or receiving signals to/from other vehicle systems connected to the data bus, such as an engine control module, body control module, transmission control module, etc. Vehicle data bus configurations include but are not limited to CAN, J-1850, LIN and GMLAN.

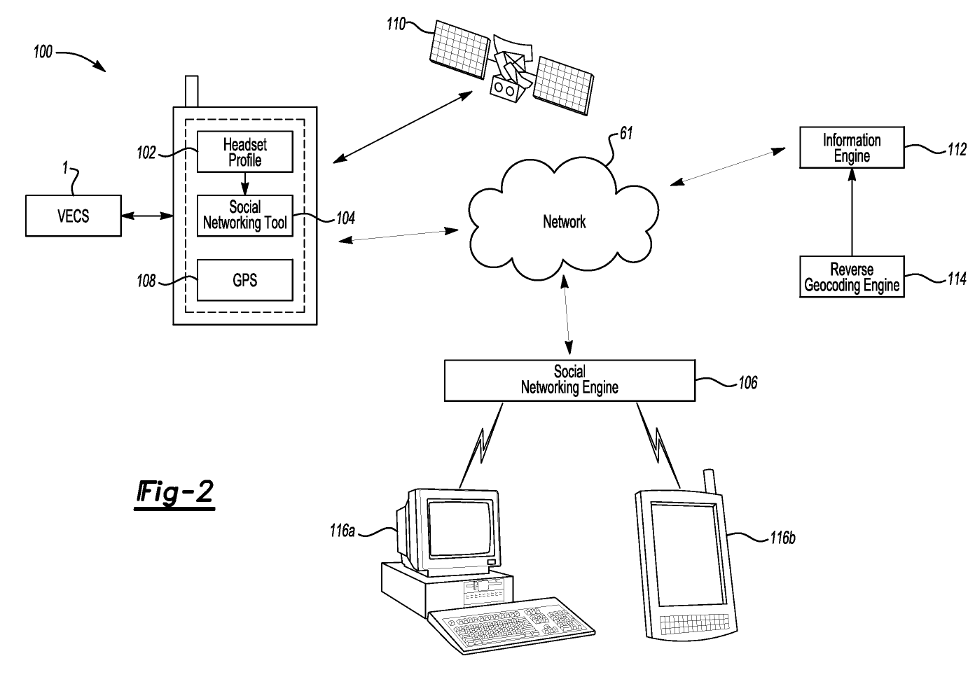

FIG. 2 is an exemplary social networking system for use with a vehicle according to one of the various embodiments of the present invention. As described above, the ND 53 may communicate with the vehicle-based computing system 1 using, in one embodiment, a BLUETOOTH connection. The ND 53 may have stored in non-volatile memory a hands-free or headset profile 102 in order to accomplish the communication with the vehicle-based computing system. The profile 102 may receive the BLUETOOTH signal from the vehicle in order to instruct the ND 53 to perform one or more actions.

The ND 53 may also store the social networking tool 104 in non-volatile memory. The social networking tool 104 may be software downloaded to the ND 53 by a user. The software may be received from, in one embodiment, a vehicle manufacturer (e.g., downloaded from a website operated by the OEM). One example of such a website is SyncMyRide.com operated by THE FORD MOTOR COMPANY. The software may, alternatively or additionally, be received from any third-party or third-party website (including, but not limited to, social networking engine 106, cell phone service providers, etc.). The social networking tool 104 may be an interface for communicating with one or more social networking engines 106. Social networking engines 106 may include, but are not limited to, social networking websites, text messaging programs, and internet chatting programs. In an alternative embodiment, the tool 104, or portions of it, may be executed at VCES 1.

The social networking tool 104 may include information associating a user with the social networking engine 106. For example, one non-limiting association may be a username and password of the user corresponding to a particular social networking system such as www.twitter.com. The software tool 104 may further include instructions for transmitting the one or more associations to the social networking engine 106.

The social networking tool 104 may be configured by a user from the ND 53, a personal computer (not shown), or from the vehicle (e.g., using the vehicle-based computing system). In one embodiment, the user may configure the social networking tool 104 before or after installation of the program to the ND 53.

In configuring the tool 104, the user may set a username and password for accessing the one or more social networking engines 106 and/or configure profile information (e.g., birthdate, address, nicknames, and contact information). The tool 104 may also be configured to establish preferences for using the tool 104. Non-limiting examples of preferences may include setting an option to automatically transmit messages to the social networking engine 106 (i.e., without receiving authorization from the user), which and how many social networking engines 106 to send a message, to whom to send the messages, when to send the messages, and how often to send the messages. The user may also customize all or part of a message, or select a default message, to be sent to the social networking engine(s) 106.

The customized or default message(s) may be displayed to one or more recipients once the recipients log in to the social networking engine 106 using assigned login information. In one embodiment, recipients may be subscribers of a news feed or syndicated feed through which the recipient may receive one or more of the users' messages. Non-limiting examples of these messages will be further described below.

The user's login, profile information, and/or customized information may be stored in the ND's 53 memory (not shown) and/or in information engine 112. Some of this information may be stored in both locations. For example, the login information may be stored in the ND's memory while the preference and customized information is stored in engine 112. Information engine 112 may or may not be associated with social networking engine 106.

It should be understood that a user may be any occupant in a vehicle and there may be any number of users that employ the use of system 100. Accordingly, messages may be transmitted from the tool 104 to each social networking engine 106 associated with each vehicle occupant.

In one embodiment, the ND 53 may also include a GPS chip 108 for receiving coordinates of the user. The GPS chip 108 may communicate with multiple GPS satellites 110 for calculating, for example (and without limitation), latitude and longitude data for the user. The GPS data may be, additionally or alternatively, received from the GPS chip 24 (FIG. 1) in the vehicle. The GPS data may be transmitted to the ND 53 from the vehicle via the BLUETOOTH connection.

Tool 104 may communicate with the social networking engine 106 over the network 61 using ND 53. Network 61 may include, but is not limited to, a public network such as the Internet.

System 100 may include additional engines with which tool 104 may communicate over wireless network 61 using ND 53. The information engine 112 may include information about the user. For example, the user's login information and/or preferences configured during installation may be stored in engine 112. The information engine 112 may be a database or an interface for communicating with a database in which the information is stored.

In one embodiment, engine 112 may also include vehicle information. Non-limiting examples of vehicle information may include vehicle branding information and ownership information. Vehicle branding information may include a make and model of the vehicle. For example, engine 112 may include information to identify the user's vehicle as a FORD ESCAPE in the message sent to one or more message recipients. A non-limiting example of a message may be “Joe's Ford Escape is leaving Dearborn, Mich.”

A reverse geocoding engine 114 may process the GPS coordinates received by GPS chip 108 (or GPS chip 24 in the vehicle) to perform a “reverse geocode.” Reverse geocoding is a process known in the art in which geographic coordinates are presented to a user in a manner that can be understood by the user (e.g., “Dearborn” or “123 Main Street”).

Engine 114 may also communicate with engine 112 to transmit, for example, location information in order to associate the location with the user. The location information may be pre-defined by the user. For example, the user may pre-define “123 Main Street” as “Home,” “456 Main Ave” as “Office,” or “789 Main Circle” as “Gym.” In one embodiment, the OEM or a third-party may also pre-define the location associations. For example, names of commercial establishments may be predefined and associated with particular addresses. The reverse geocoded information from engine 114 may be received by engine 112 and associated with the user based on the one or more pre-defined associations.

Additionally, geographic areas or radiuses from a particular location may be given a name such as “school” or “Mark's work,” etc.

The messages transmitted from tool 104 to social networking engine 106 may be viewed by the one or more recipients from terminals 116a and/or 116b. Terminals 116a, 116b may be personal computers, cellphones, smartphones, or other terminals having Internet capabilities. Terminals 116a, 116b may or may not include graphic user interface (GUI) displays for viewing the messages.

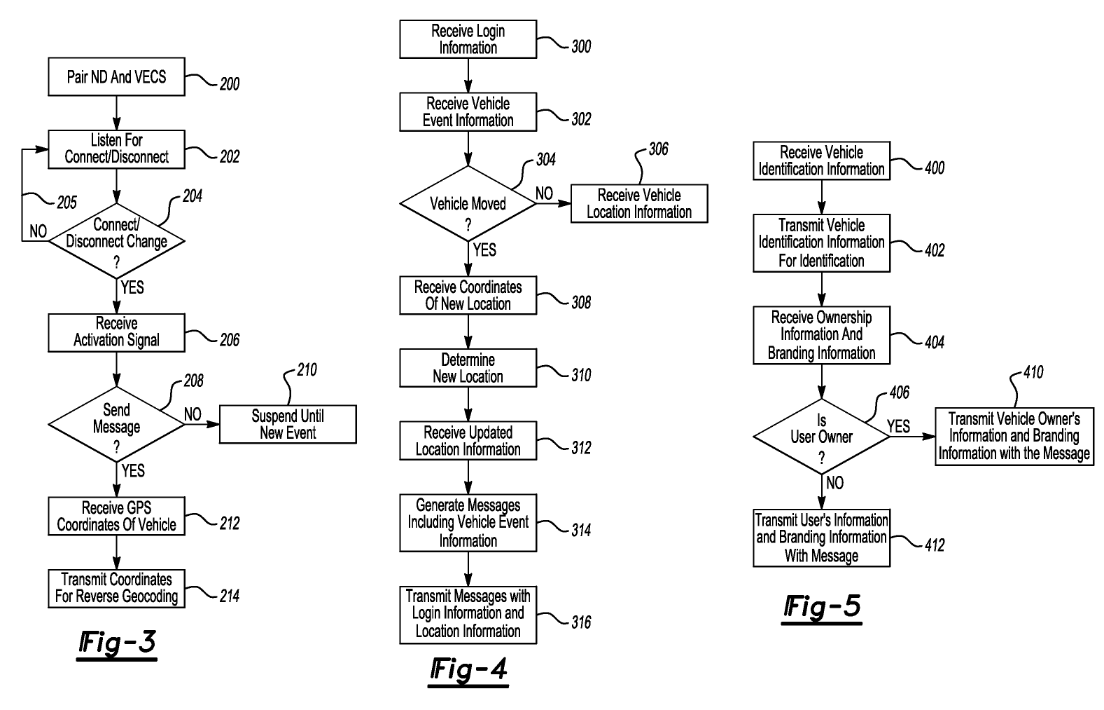

FIG. 3 shows the operation of a vehicular social networking tool according to one of the various embodiments of the present invention. The ND 53 may be paired with the VECS 1, as illustrated in block 200, for generating a connection between the VECS 1 and the ND 53. Once the VECS 1 and the ND 53 have connected (or disconnected), the social networking tool 104 may communicate with the profile 102 to listen for the connection signal (or lack of a connection signal representing a disconnection) between the VECS 1 and the ND 53 as illustrated in block 202. It should be understood that pairing may occur once, such that the VECS 1 and ND 53 automatically connect upon powering the vehicle (or the VECS 1), or pairing (and the subsequent connections) may occur multiple times. The connection signal may be generated, for example, when a vehicle occupant turns the ignition key to power the VECS 1. Alternatively, there may be a lack of connection when the vehicle occupant turns the ignition key to power off the VECS 1.

In one embodiment, the connection signal or lack of a connection signal may be interpreted by the tool 104 as a vehicle departure or arrival event of the vehicle, respectively. As such, the connection signal or lack of a connection signal may be a trigger for activating the functions of the social networking tool 104.

A determination may be made whether the BLUETOOTH connection status has changed as illustrated in block 204. If the status has not changed, the tool 104 may continue to listen for a change in the connection status as illustrated by loop 205.

If the connection status has changed, the tool 104 may receive the activation signal as illustrated in block 206.

In another embodiment, the arrival or departure event may be based on the status of the vehicle's ignition. Tool 104 may be activated in response to an ignition signal change received from a vehicle bus network and transmitted through the VECS 1. In such an embodiment, a translation or lookup (via a lookup table) may occur in the ND 53 (e.g., in a microprocessor (not shown)) to identify the ignition status change transmitted from the vehicle.

Referring back to FIG. 3, upon receiving the connection signal, a determination may be made whether a message is to be sent from the tool 104 as illustrated in block 208. The message may be displayed to the user on display 4, on the ND's display (not shown), or outputted in a spoken language through speaker 13. CPU 3 may include speech recognition software for outputting the message from text to speech. The user may confirm or deny transmission of a message from ND 53 or through a voice-activated command. In one embodiment, if the user has set a preference to automatically transmit the message, this determination may not be made by tool 104.

If the user does not wish to transmit a message, then tool 104 may suspend transmission of messages until a new vehicle event as illustrated in block 210. As discussed above, a non-limiting example of an event may include a connection status change or an ignition position change. In other embodiments, other vehicle events may include, but are not limited to, a gear change position, the passage of a predetermined time (as defined by the user), an impact event on the vehicle, or airbag deployment. A gear change position may include, but is not limited to, changing to and/or from a drive position, a park position, a reverse position, one or more gears in a manual transmission, or a low gear position in an automatic transmission. In yet another embodiment, the user may define custom events that, upon detection, initiate a message transmission.

If a message is to be transmitted, the geographic coordinates of the vehicle may be determined by the GPS chip 108 based on data received from one or more satellites 110. The geographic coordinates may be determined as latitude and longitude coordinates. In one embodiment, the ND 53 may receive the signal identifying the request to transmit the message and, in turn, transmit a signal (with instructions) to the GPS chip 108 to determine the coordinates. In another embodiment, the instructions may be transmitted by the tool 104.

The coordinates determined by the GPS chip 108 may be received by the tool 104, as illustrated in block 212, and transmitted from the ND 53 to the reverse geocoding engine 114 as illustrated in block 214. In one embodiment, the coordinates may be transmitted from the ND 53 to the engine 114 once the GPS chip collects the coordinate information. The coordinate information may be transmitted over wireless network 61. Alternatively, geocoding may be resolved by pre-defined coordinates, areas or a radius from a particular latitude/longitude.

FIG. 4 illustrates another exemplary operation of vehicular social networking according to one of the various embodiments. The tool 104 may receive data representing the association between the user and the social networking engine 106 as illustrated in block 300. In one embodiment, this association may be login information for the user (e.g., a username and password). This association may or may not be received upon activating a transmission trigger at the social networking tool 104. Once the tool 104 is activated or triggered, the tool 104 may receive or retrieve the vehicle event information as illustrated in block 302.

In one embodiment, a determination may be made whether the vehicle moved since the last coordinate determination (block 212) as illustrated in block 304. If there was no change in coordinate position, the location information may be transmitted from engine 114 and received by tool 104 as illustrated in block 306. In this case, no status update may be necessary.

If there was a vehicle position change, the new coordinates may be calculated by the GPS chip 108 as illustrated in block 308. The new location information may be determined (e.g., at engine 112), as illustrated in block 310, and the updated location information of the vehicle may be received by the tool 104 as illustrated in block 312.

In one embodiment, the reverse geocode engine 114 may communicate with information engine 112 to obtain the reverse geocoded location information. The user may predefine particular locations and store the information in information engine 112. For example, the user may pre-define “123 Main Street” as “Home,” “456 Main Ave” as “Office,” or “789 Main Circle” as “Gym.” Additionally or alternatively, information engine 112 may include associations predefined by others (e.g., the OEM).

Engine 114 may receive the geographic coordinates, determine the location of the user and transmit the location information to information engine 112. Engine 112 and engine 114 may communicate over a wireless network (such as via network 61) or via electrical communication. The information engine 112 may associate the location information with the predefined associations. For example, a relational association may exist between location information and the predefined associations to select the reverse geocoded location information based on the location information received from the engine 114.

One or more data packets may be generated including the vehicle event information as illustrated in block 314. The one or more data packets may be sent by the ND 53 as messages to the social networking engine 106 as illustrated in block 316. In one embodiment, the login information and the location information may be sent with the data packets.

In one embodiment, the one or more data packets may be sent by information engine 112 to the social networking engine 106 without transmitting information back to ND 53. In this non-limiting embodiment, data including, but not limited to, login information and location information may be received by the information engine 112 and transmitted to the social networking engine 106.

The messages may include additional information. FIG. 5 illustrates including vehicle information and branding information in the one or more data packets according to one of the various embodiments. As illustrated in block 400, tool 104 may receive vehicle identification information (e.g., and without limitation, a vehicle identification number (VIN)) for receiving vehicle information from information engine 112. Information engine 112 may include one or more databases (not shown) having vehicle information data arranged according to VIN numbers. Non-limiting examples of vehicle information may include vehicle ownership information and branding information.

The VIN may be transmitted to the engine 112 as illustrated in block 402. The engine 112 may retrieve the vehicle information according to the VIN. For example, engine 112 may retrieve information identifying the vehicle as “Joe's” and that Joe's vehicle is a “Ford Escape.”

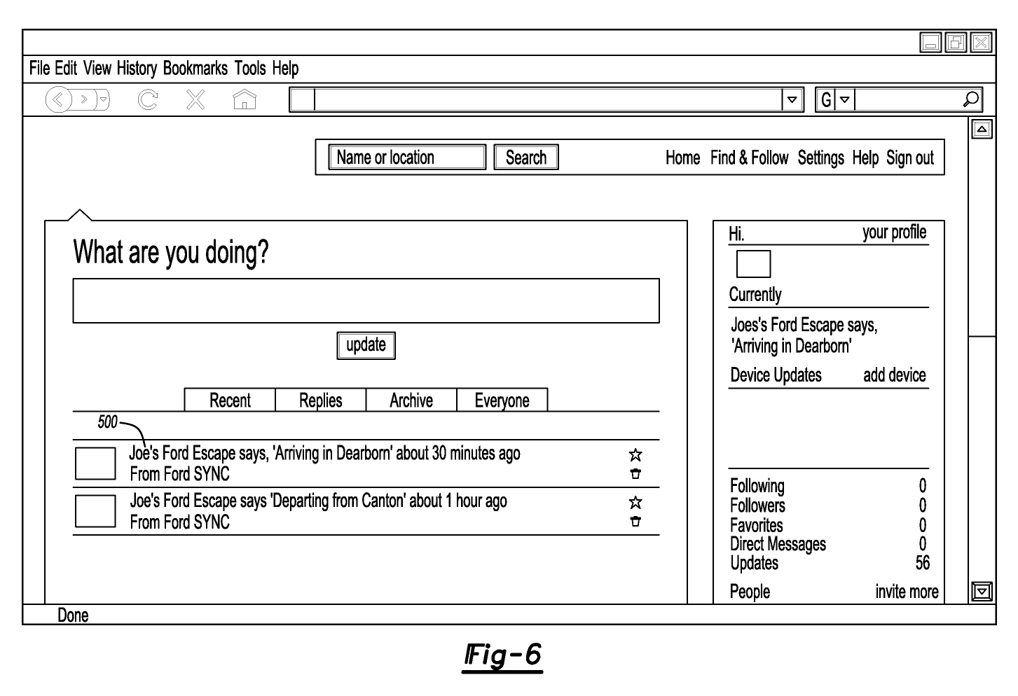

The vehicle information may be received by tool 104 as illustrated in block 404. Additionally, tool 104 may determine ownership of the vehicle as illustrated in block 406. If the vehicle owner (as identified from engine 112) is the user, the message transmitted to social networking engine 106 may state the event or activity engaged in by the vehicle owner and the vehicle owner's personal identification information (e.g., and without limitation a name) as illustrated in block 410. For example, the message may state, “Joe's Ford Escape says ‘Joe has arrived in Dearborn.’” FIG. 6 illustrates, in one embodiment, the content of the message when the user is the vehicle owner. As shown in FIG. 6, the message 500 may state “Joe's Ford Escape says ‘Arriving in Dearborn.’”

If the user is not the vehicle owner, the message may include information stating the activity or event in which the user (i.e., the occupant) is engaged and personal identification information for the user (e.g., and without limitation, a name) as illustrated in block 412. For example, the message viewed by the one or more recipients from terminal 116a, 116b may state, “Joe's Ford Escape says ‘Matt has arrived in Dearborn.’”

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A computer-implemented method for automatically updating a social networking system based on vehicle events, the method comprising:
receiving login information at a nomadic wireless communication device (NWCD) permitting network access to a social networking system;
wirelessly determining a vehicle operational status at the NWCD, wherein the vehicle is located in proximity of the NWCD;
receiving geographic location information indicating an approximate location of the vehicle;
generating one or more messages based on the vehicle operational status and the location information;
obtaining network access to the social networking system using the login information; and
transmitting the one or more messages to the social networking system over the network for updating information on the social networking system.

2. The computer-implemented method of claim 1 wherein the one or more messages identify a social networking system user arriving at a location, departing from a location, or both.

3. The computer-implemented method of claim 1 further comprising receiving vehicle ownership information, wherein the transmitting step further includes transmitting the vehicle ownership information.

4. The computer-implemented method of claim 1 further comprising receiving vehicle branding information, wherein the transmitting step further includes transmitting the vehicle branding information.

5. The computer-implemented method of claim 1 wherein the vehicle operational status is determined according to a pairing status between the NWCD and a vehicle computing system.

6. The computer-implemented method of claim 1 wherein the vehicle operational status is based on a vehicle's ignition status.

7. The computer-implemented method of claim 1 wherein the geographic location information is user-defined location information.

8. The computer-implemented method of claim 1 wherein the one or more messages and the vehicle location are displayed at the social networking system.

9. The computer-implemented method of claim 1 wherein the NWCD is a cellphone and the method is implemented in computer software executing on the cellphone.

10. The computer-implemented method of claim 1 wherein the social networking system is a web-based entity and the method further comprises transmitting the one or more messages and the vehicle location to the web-based entity.

11. A computer-program product embodied in a computer-readable medium programmed for automatically updating a social networking system based on vehicle events, the computer-program product comprising instructions for:
receiving login information permitting network access to a social networking system;
wirelessly determining an operational status of a vehicle located in proximity to a nomadic wireless communication device (NWCD);
receiving geographic location information indicating an approximate location of the vehicle;
generating one or more messages based on the vehicle operational status and the location information;
using the NWCD, obtaining network access to the social networking system using the login information; and
using the NWCD, transmitting the one or more messages to the social networking system over the network for updating information on the social networking system.

12. The computer program product of claim 11 wherein the operational status of the vehicle is based on a transmission position of the vehicle.

13. The computer program product of claim 11 wherein the vehicle operational status is determined based on a pairing status between the NWCD and a vehicle computing system and a transmission position of the vehicle.

14. The computer program product of claim 11 wherein the one or more messages identify a social networking system user arriving at a location, departing from a location, or both.

15. The computer program product of claim 11 wherein the location information includes a name of a location.

16. The computer program product of claim 15 wherein the location name is user-defined.

17. The computer program product of claim 11 further comprising instructions for:
receiving personal information identifying a social networking system user; and
transmitting the identifying personal information with the one or more messages.

18. The computer program product of claim 11 wherein the social networking system is a short messaging service (SMS) program and the computer program product further includes instructions for transmitting the one or more messages and the vehicle location to the SMS program.

19. A computer-implemented system for automatically updating a social networking system based on vehicle events, the system comprising:
at least one computer configured to:
pair a nomadic wireless communication device (NWCD) with a vehicle computing system;
receive login information permitting network access to a social networking system;
determine an operational status of a vehicle located in proximity of the NWCD;
receive geographic location information indicating an approximate location of the vehicle;
generate one or more messages based on the vehicle operational status and the location information;
obtain network access to the social networking system using the login information; and
transmit the one or more messages to the social networking system over the network for updating information on the social networking system.

20. The computer program product of claim 19 wherein the operational status of the vehicle is determined based on a pairing status between the NWCD and the vehicle computing system.
